(19) United States
(12) Patent Application Publication
(10) Pub. No.: US 2005/0068646 A1
(43) Pub. Date: Mar. 31, 2005

(54) Mirror with adjustable magnification and with a plurality of displays and devices

(75) Inventors: Mordechai Lev, West Bloomfield, MI (US); Shachar Golan, Walled Lake, MI (US); John E. Nemazi, Bloomfield Hills, MI (US)

Correspondence Address: BROOKS KUSHMAN P.C., 1000 TOWN CENTER, TWENTY-SECOND FLOOR, SOUTHFIELD, MI, 48075, US

(73) Assignee: HoMedics, Inc., Commerce Township, MI (US)

(21) Appl. No.: 10/671,168

(22) Filed: Sep. 25, 2003

(51) Int. Cl. B41J 2/01

(52) U.S. Cl. 359/871; 359/432

(57) ABSTRACT

A variable magnification cosmetic mirror apparatus for is disclosed. The cosmetic mirror comprises a reflective flexible substrate, a housing assembly and a motor assembly. The motor provides power to curve the flexible substrate to control a magnification factor of the flexible substrate. Further, a manual variable magnification cosmetic mirror apparatus with an annular connection to the reflective substrate is disclosed. The annular connection provides control of the magnification factor of the flexible substrate with minimal image distortion. Further, a dual cosmetic mirror apparatus with a plurality of displays, devices, and light sources is provided.

### BACKGROUND OF THE INVENTION

1. Field of the Invention

The present invention relates to a mirror generally used for personal hygiene, application of cosmetics, and the like. More particularly, the invention relates to a mirror having a user defined variable magnification factor. Further, the invention relates to a mirror offering a plurality of information displays, light sources, and devices.

2. Background Art

Cosmetic mirrors are used for personal hygiene, application and removal of cosmetics, removal and installation of contact lenses, and the like. Conventional cosmetic mirrors come in either dual mirror or single mirror configurations. Dual mirror configurations generally have two mirrors, each mirror with substantially different degrees of curvature from the other. Single mirror configurations may offer a variable magnification factor mirror. Variable magnification cosmetic mirrors allows a user to adjust the magnification factor according to their usage requirement.

However, variable magnification mirrors do not offer a plurality of magnification levels. Generally, conventional variable magnification mirrors offer two settings, such as flat or concave. Further, adjustable magnification mirrors may require a great deal of effort and force for adjustments. Therefore, there is a need for a cosmetic mirror that offers a convenient way to adjust the magnification of the mirror with minimal effort and minimal mirror distortion over a greater range of magnifications. It would be desirable to integrate a small electric motor to control magnification of a mirror for greater precision and consistency over a greater range of magnifications. The motor can be controlled by a switch to make using the mirror easier.

In other conventional variable magnification mirrors, the flexing of the mirror is accomplished with a puller plate connection attached to the rear surface of the mirror. Generally, the puller plate attaches to the rear surface of the mirror with a circular engagement area. However, conventional puller plates do not produce fine paraboloids which offer an image with less distortion on both flat and concave mirrors. Thus, there exists a need for an attachment scheme to the mirror to produce images with less distortion on both flat and concave mirrors.

In addition, cosmetic mirrors are often used in areas where space may be limited, such as the bathroom counter top or a vanity table. These spaces may also have a limited number of electrical outlets needed for personal hygiene and appliances in these areas such as clocks or night lights. Therefore, it is desirable for a cosmetic mirror offering the functionality of several devices, such as lighting and information displays, integrated into the cosmetic mirror while minimizing the number of electrical sources necessary and conserving space.

This invention addresses the above noted problems and fulfills the above needs as summarized below.

### SUMMARY OF THE INVENTION

The present invention provides a motorized variable magnification factor cosmetic mirror comprising a housing having an internal annular region oriented about a central axis. A flexible substrate having a peripheral edge, a front surface, and an opposed rear surface, where the peripheral edge is affixed to the housing. A connector extends centrally from the rear surface. A reflective coating is provided onto one of the front and rear surfaces. The reflective coating causes the substrate to be reflective when viewed by a user from the front surface side. An electric motor/transmission assembly is mounted to the housing. The electric motor/transmission assembly has an output member, operably engaged with the connector, for displacing the connector fore and aft relative to the housing annular region and consequently flexing a central portion of the substrate fore and aft relative to the housing annular region thus varying the magnification factor of the flexible surface. An user-selectable switch connecting a source of power to the electric motor/transmission assembly for providing user adjustment of the magnification factor of the substrate.

Another object of the invention is to provide a mirror in which the magnification may be varied manually over a substantial range of magnifications. The manual variable magnification factor mirror comprising a housing with an internal annular region formed about a central axis. A flexible substrate with a peripheral edge, a front surface, and an opposed rear surface. The peripheral edge is affixed to the housing. An annular connector extending centrally from the rear surface. A reflective coating is provided onto one of the front and rear surfaces. The reflective coating causes the substrate to be reflective when viewed by a user from the front surface side. A handle shiftably connected to the housing and operably engaged with the connector. The movement of the handle displaces the connector fore and aft along to the housing central axis and consequently flexing a central portion of the flexible substrate thus varying the magnification of an image viewed by the user.

In yet another object of the invention a double-sided cosmetic mirror with a plurality of devices is provided. The double-sided cosmetic mirror comprising a housing with a first end opening and a second end opening. A first substrate having a first peripheral edge, a first front surface, and an opposed first rear surface. The first peripheral edge is affixed within the first opening of the housing. A first reflective coating provided onto one of the first front and the first rear surfaces. The first reflective coating causes the first substrate to be reflective when viewed by a user from the first front surface side. A second substrate having a curvature substantially different from the first substrate. The second substrate having a second peripheral edge, a second front surface, and an opposed second rear surface, the second peripheral edge being affixed within the second opening of the housing. A second reflective coating provided onto one of the second front and the second rear surfaces. The second reflective coating causing the second substrate to be reflective when viewed by the user from the second front surface side. A first information display oriented the first substrate for being viewable by a user. A second information display oriented the second substrate for being viewable by the user. An information source circuit connected to and controlling both the first and second information displays. At least one user selectable switch cooperating with the information source circuit for controlling the first and second information displays.

### BRIEF DESCRIPTION OF THE DRAWINGS

FIG. 1 is an exploded perspective view of a motorized variable magnification cosmetic mirror in accordance with the present invention;

FIG. 2 is a rear perspective view of the assembled motorized variable magnification cosmetic mirror of the present invention;

FIG. 3 is a cross-sectional view of the assembled variable magnification cosmetic mirror of the present invention;

FIG. 4a is an exploded perspective view of a manual variable magnification cosmetic mirror in another embodiment of the present invention;

FIG. 4b is a plan view of a connector having an annular attachment area to reduce average tensions of the present invention;

FIG. 4c is a plan view of a connector having zones of annular attachment to reduce average tensions in these zones of the present invention;

FIG. 5 is a rear perspective view of the assembled manual variable magnification cosmetic mirror of the present invention;

FIG. 6 is a cross-sectional view of the assembled manual variable magnification cosmetic mirror of the present invention;

FIG. 7 is a diagram illustrating the movement of the handle for adjusting the magnification factor of the manual variable magnification cosmetic mirror of the present invention;

FIG. 8 is an exploded perspective view of a dual sided cosmetic mirror with a plurality of displays and lights of the present invention;

FIG. 9 is a perspective view of an assembled dual sided cosmetic mirror of the present invention; and

FIG. 10 is a diagram of a cosmetic mirror with a plurality of integrated devices of the present invention.

### DETAILED DESCRIPTION OF THE PREFERRED EMBODIMENT(S)

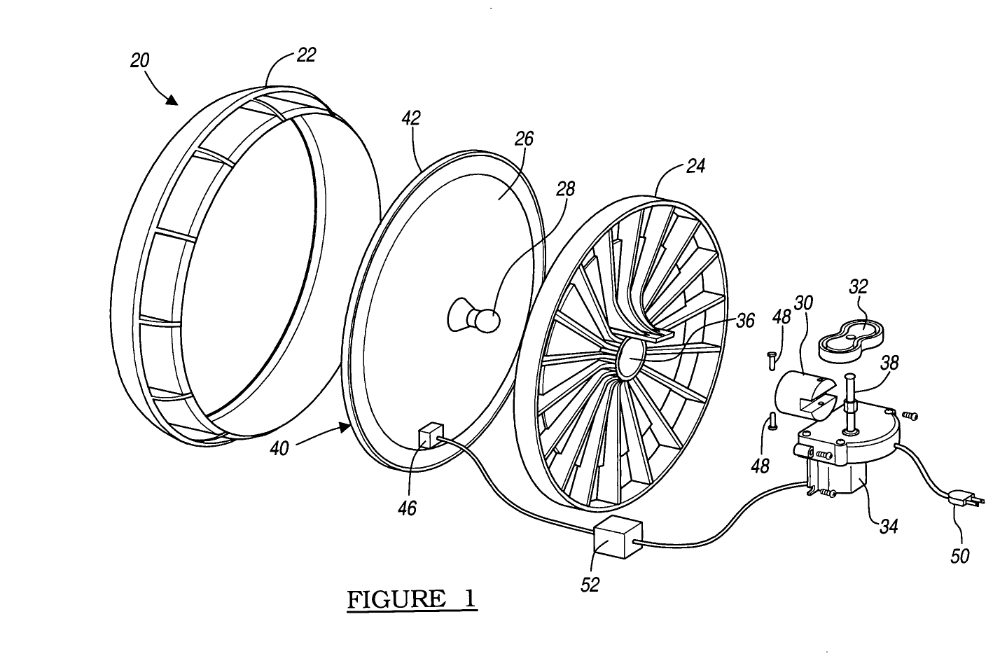

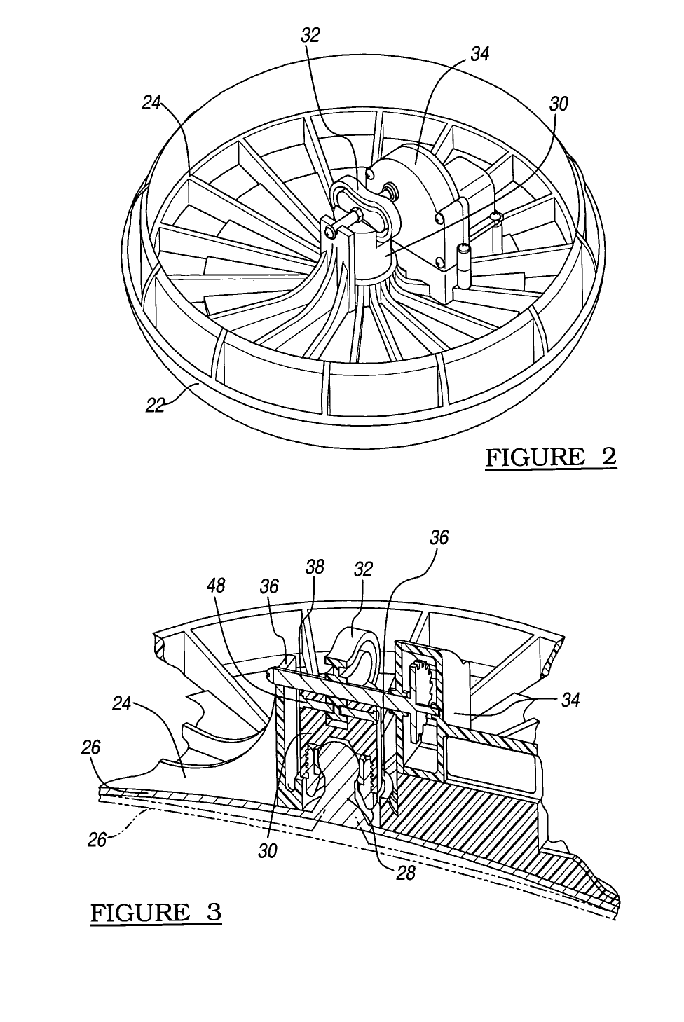

Referring now to FIG. 1, a motorized variable magnification cosmetic mirror 20 of the present invention is shown in an exploded perspective view. Assembly of the motorized variable magnification cosmetic mirror is shown in FIG. 2. The principal structural components of motorized variable magnification cosmetic mirror 20 include a housing including an external portion 22 and an internal frame 24, a flexible substrate 26, a connector 28, a connector attachment 30, and an electric motor/transmission assembly 34.

External portion 22 and internal frame 24 create the housing for motorized variable magnification cosmetic mirror 20. External portion 22 of the housing includes an internal annular region oriented about a central axis. Internal annular region may provide an inner rim 23 for receiving a periphery of flexible substrate 26.

Internal frame 24 of the housing includes an aperture 36 for allowing connector 28 and connector attachment 30 to pass through and connect with an output member 38 of electric motor/transmission assembly 34. Internal frame also provides a limit to curvature and assists in the shaping of flexible substrate 26.

Flexible substrate 26 includes peripheral edge 40, a front surface 42, and a rear surface 44. A reflective coating is applied to either the front surface or the rear surface causing the flexible substrate to be reflective when viewed by a user from front surface 42. Flexible substrate 26 may also receive displays, light sources, or devices like a switch 46.

Connector 28 extends centrally away from the rear surface of flexible substrate 26. Connector 28 pulls perpendicular to flexible substrate 26 to change the magnification factor of the flexible substrate without image distorting side forces. Further, connector 28 may include an annular connection to rear surface 44 for minimal distortion of the reflected image. Connector 28 may be a ball joint or any other form of connection or joint that can attach with connector attachment 30.

Connector attachment 30 receives connector 28. Connector attachment 30 passes through aperture 32 and attaches to output member 38 using a cam 32 and a set of pins 48. Cam 32 attaches to output shaft 38 with pins 48 which slide into the tracks of the cam.

Electric motor/transmission assembly 34 is mounted on internal frame 24 and includes output member 38 which receives cam 32 which attaches to connector attachment 30. The movement of connector attachment 30 fore and aft relative to internal frame 24 curves flexible substrate 26 for varying the magnification factor. Electric motor/transmission assembly 34 offers a user easier use and greater precision in setting the magnification factor of flexible substrate 26. Electric motor/transmission assembly 34 or the size of cam 32 may also limit the range of curvature of the flexible substrate.

Electric motor/transmission assembly 34 may be any DC micro motor or any other small electric motor. The power of the motor is enough to move connector attachment 30 fore and aft to inner frame 24 for controlling the magnification factor of flexible substrate 26.

Switch 46 is connected to a source of power 50 and controls electric motor/transmission assembly 34 to adjust the magnification level of flexible substrate 26. Switch may be received by external portion 32 of the housing or flexible substrate 26. Switch may be a touch sensor with capacitive responsive electronic switching circuit 52 controlling operation thereof.

Cosmetic mirror 20 may also include information displays, devices, or light sources. Information displays, devices, and light sources may be received by external portion 22, mounted on front surface 42, mounted on rear surface 44, integrated or etched between layers of flexible substrate 26, or oriented in a non-reflective portion of the flexible substrate.

Devices integrated into cosmetic mirror 20 may include make-up pencil sharpeners, fans, or any other devices needed for personal hygiene or found in the area where the cosmetic mirrors may be used. Information displays, devices, and light sources may also feature an automatic shutoff and alarm functions. The light sources may have a plurality of settings including day, night, and a night light option.

Referring now to FIG. 2, a diagram illustrating a rear perspective view of the assembled motorized variable magnification cosmetic mirror 20 of the present invention is shown.

Referring now to FIG. 3, a diagram illustrating a cross section view of the assembled variable magnification cosmetic mirror 20 of the present invention is shown. Connector 28 is received by connector attachment 30, which is connected to output member 38 via cam 50. Connector attachment 30 receives pins 48 to attach to cam 50 which attaches to output member 38. As output member 38 rotates, cam 50 rotates to move the connector attachment 30 fore and aft relative to inner frame 24 to change the magnification factor of flexible substrate 26 as shown. The pull force applied to flexible substrate 26 is always perpendicular to the surface of the flexible substrate which prevents side forces from causing image distortion.

The magnification factor of flexible substrate 26 may be limited by inner frame 24, which may limit the maximum range of curvature. The arc of inner frame 24 is calculated to the radius of maximum magnification. Maximum magnification may be reached when flexible substrate 26 is fully pressed against the arc of inner frame 24. Further, the maximum range of curvature of flexible substrate 26 may be limited by the size of cam 50 or the operation of electric motor/transmission assembly 34.

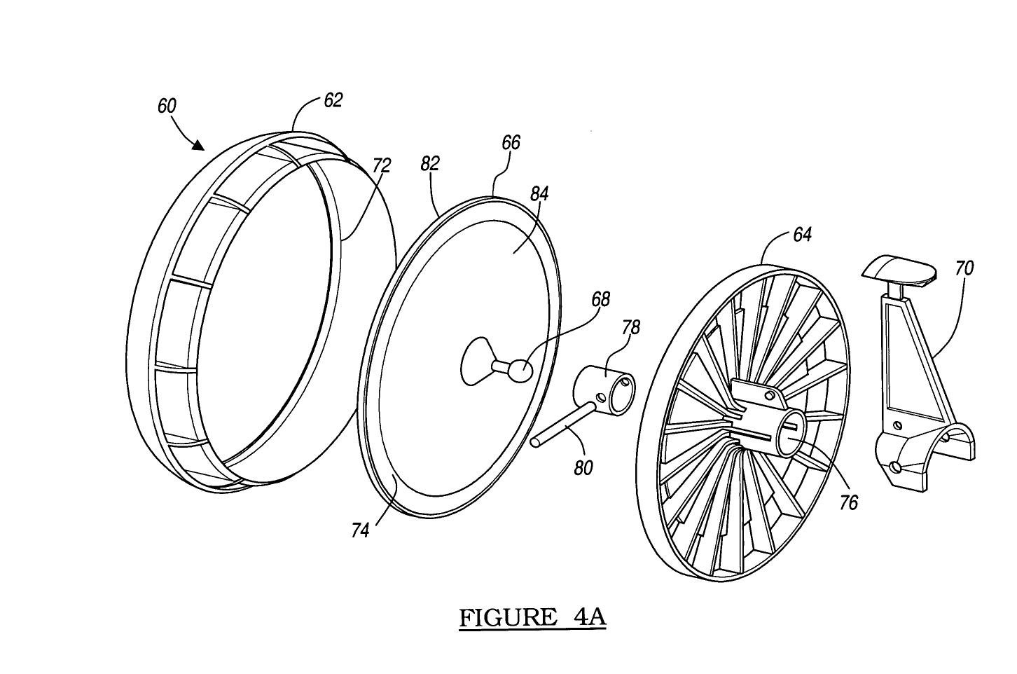

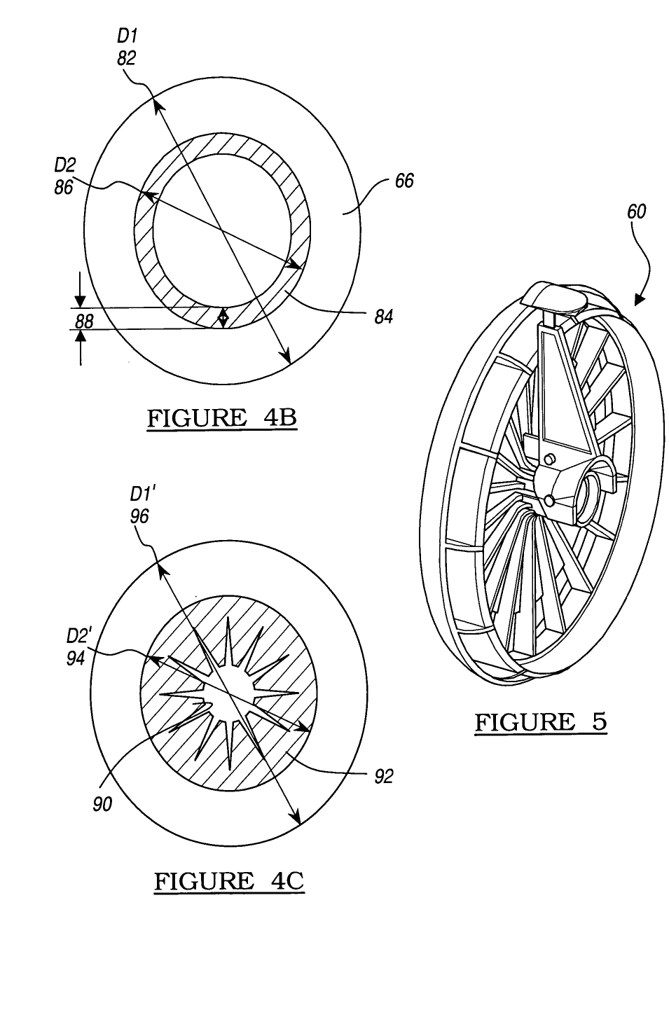

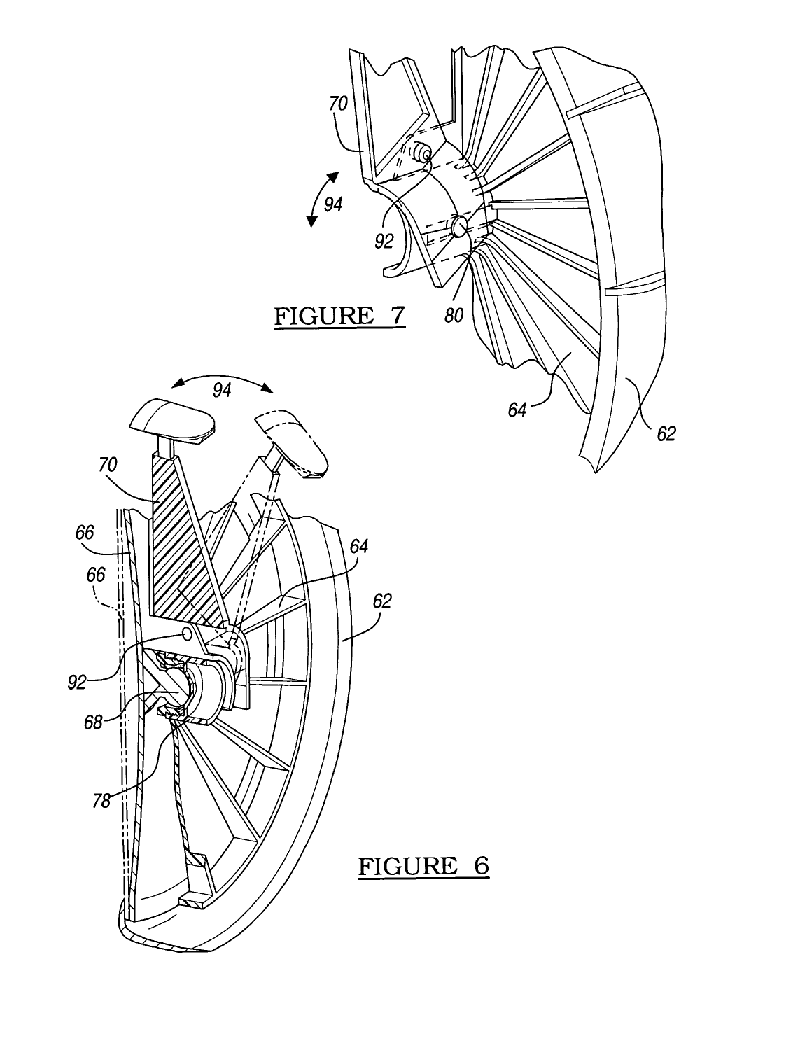

Referring now to FIG. 4a, a manual variable magnification cosmetic mirror 60 in another embodiment of the present invention is shown in an exploded perspective view. Assembly of the handle variable magnification cosmetic mirror is shown in FIG. 5. The principal structural components of manual variable magnification cosmetic mirror 60 include a housing including an external portion 62 and an internal frame 64, a flexible substrate 66, annular connector 68, and a handle 70.

External portion 62 and internal frame 64 create the housing for manual variable magnification cosmetic mirror 60. External portion 62 of the housing includes an internal annular region oriented about a central axis. Internal annular region may include an inner rim 72 for receiving a periphery of flexible substrate 74.

Internal frame 64 of the housing includes an aperture 76 for allowing annular connector 68 to pass through and connect with the handle. Annular connector 68 may connect with handle 70 using an annular connector attachment 78. Handle 70 attaches to annular connector attachment 78 with a pin 80. Internal frame 64 also provides a limit to curvature and assists in shaping of flexible substrate 66.

Flexible substrate 66 includes peripheral edge 74, a front surface 82, and a rear surface 84. A reflective coating is applied to either front surface 82 or rear surface 84 causing flexible substrate 66 to be reflective when viewed by a user from the front surface. Flexible substrate 66 may also receive displays, devices or light sources. Such displays, devices, and lights may be received by external portion 62 of the housing, mounted on front surface 82, mounted on rear surface 84, integrated or etched between layers of flexible substrate 66, or oriented in a non-reflective portion of the flexible substrate.

Annular connector 68 extends centrally away from rear surface 84 of flexible substrate 66. Annular connector 68 engages rear surface 84 in an annular region. Annular connector 68 pulls perpendicular to flexible substrate 66 to change the magnification factor of the flexible substrate to produce fine paraboloids without image distorting side forces. Annular connector 68 may include a ball joint or any other form of connection or joint that can connect with annular connector attachment 78.

Handle 70 may be mounted on internal frame 64. Annular connector attachment 78 and pin 80 connect annular connector 68 with handle 70. Annular connector attachment 78 connects to annular connector 68 and passes through aperture 76. The movement of annular connector 68 and annular connector attachment 78 fore and aft relative to internal frame 64 curves flexible substrate 66 for varying the magnification factor. Handle 70 may include detents or settings to allow the user to incrementally adjust the magnification factor of flexible substrate 66.

Referring now to FIG. 4b, a plan view of a connector having an annular attachment area to reduce average tensions of the present invention is provided. D₁ 82 provides an outside diameter of flexible substrate 66. Hatched section 84 illustrates an annular attachment area for annular connector 68. Outside diameter D₂ 86 of annular attachment region should be at least one fourth of diameter D₁ to achieve a paraboloid producing the reflective image with minimal distortion. Width of annular attachment region 88 is set to achieve the desired optical shape of flexible substrate 66 with a reduction of average tensions and minimal distortion.

Referring now to FIG. 4c, a plan view of a connector having zones 90 of annular attachment to reduce average tensions in these zones of the present invention is provided. Hatched section 92 illustrates an annular attachment region for annular connector 68. Zones 90 reduce the average tensions in these zones to achieve a paraboloid. To achieve a paraboloid for minimal distortion of reflected images, it is important that annular connector 68 engages flexible substrate 66 over a region having an outside diameter D′₂ 94 of at least one fourth of the diameter of the flexible substrate D′₁ 96.

The embodiments of 4b and 4c are applicable to flexible substrates having either a flat or convex rear surfaces.

Referring now to FIG. 5, a diagram illustrating a rear perspective view of the assembled manual variable magnification cosmetic mirror 60 of the present invention is shown.

Referring now to FIG. 6, a diagram illustrating a cross section view of the assembled manual variable magnification cosmetic mirror of the present invention is shown. Annular connector 68 is received by annular connector attachment 78, which is connected to handle 70. Handle 70 is attached to inner frame 64 with a pivot pin 92. As handle 70 is moved forwards and backwards, as indicated by arrow 94, annular connector attachment 78 moves fore and aft relative to inner frame 24 to adjust the magnification factor of flexible substrate 66. The pull force applied to flexible substrate 66 is always perpendicular to the surface of the flexible substrate which prevents image distorting side forces.

Referring now to FIG. 7, a diagram illustrating the movement of handle 70 for adjusting the magnification factor of manual variable magnification cosmetic mirror 60 of the present invention is shown. Handle 70 may be pulled forwards and rearward, as indicated by arrow 94, to adjust the magnification factor of flexible substrate 66. Handle 70 may also be configured to be engaged in a plurality of methods, such as pulling side to side or twisting to adjust the magnification factor of flexible substrate 66. Handle 70 and inner frame 64 may have detents or settings for different levels of magnification.

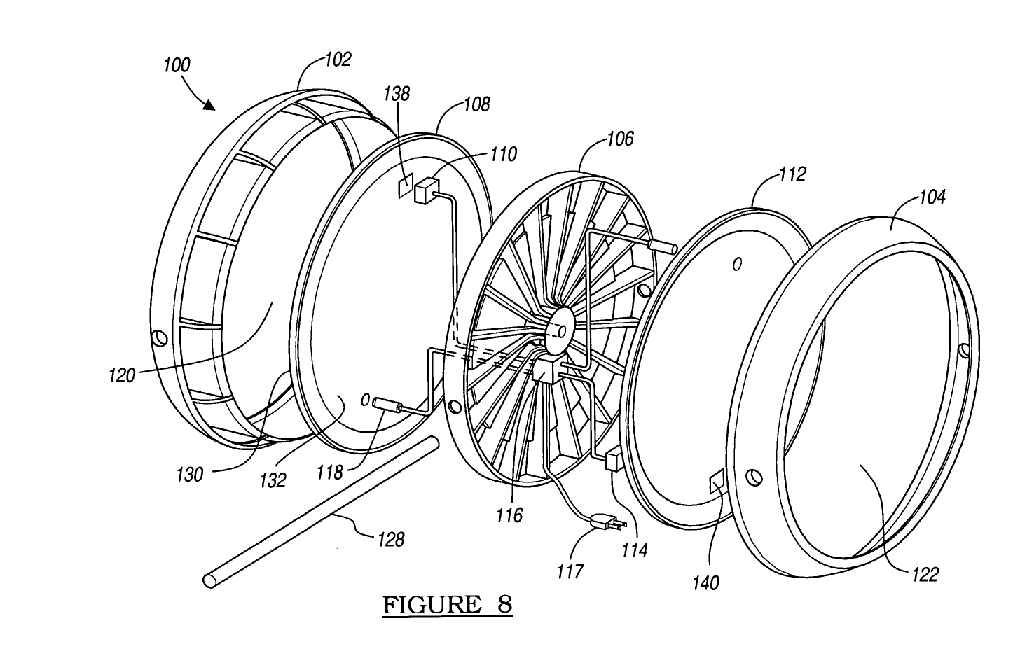

Referring now to FIG. 8, a dual sided cosmetic mirror with a plurality of displays and lights is shown in an exploded perspective view. The principal structural components of dual sided mirror 100 includes a housing including a first housing 102, second housing 104, and a internal frame 106, a first substrate 108 with a first display 110, a second substrate 112 with a second display 114, an information circuit 116, and at least one user selectable switch 118.

Both first 102 and second 204 housings include a first end opening 120 and a second end opening 122, respectively. First end opening 120 and second end opening 122 receive a first peripheral edge 124 of first substrate 108 and a second peripheral edge 126 of second substrate 112 respectively. Internal frame 106 may receive information circuit 116 and a pivot axle 128.

First substrate 108 has first peripheral edge 124, a first front surface 130, and an opposed first rear surface 132. First peripheral edge 124 may be affixed within first opening 120. First substrate 108 includes a first reflective coating provided onto one of first front 130 or first rear 132 surfaces causing the first substrate to be reflective when viewed by a user from the first front surface. First substrate 108 receives the first information display 110 so that it is viewable by a user.

Second substrate 112 has a curvature substantially different from first substrate 108. Second substrate 112 has second peripheral edge 126, a second front surface 134, and an opposed second rear surface 136. Second peripheral edge 126 may be affixed within second opening 122. Second substrate 112 includes a second reflective coating provided onto one of second front 134 and second rear 136 surfaces causing the second substrate to be reflective when viewed by the user from the second front surface. Second substrate 112 receives second information display 114 to be viewable by the user.

Information source circuit 116 is connected to and controls both first 110 and second 114 information displays. Information source circuit 116 may be any circuit offering any form of information, such as a clock circuit or a thermometer circuit. Information source circuit 116 may be received by internal frame 106 and connects to a source of power 117. First display 110 and second display 114 may be placed on respective front surfaces 130,134, respective rear surfaces 132,136, integrated within the layers of the respective substrates 108,112, or within a first 138 or second 140 non-reflective portion in the respective substrates. First 108 and second 112 substrates may have respective information displays 110, 114 etched within the surface of the substrate either on the front or rear surface to be viewable by the user.

At least one user selectable switch 118 cooperates with information source circuit 116 for controlling first 110 and second 114 information displays. Switch 118 may be received by first 102 and second 104 housings, by first 108 and second 112 substrates, or by a base 142.

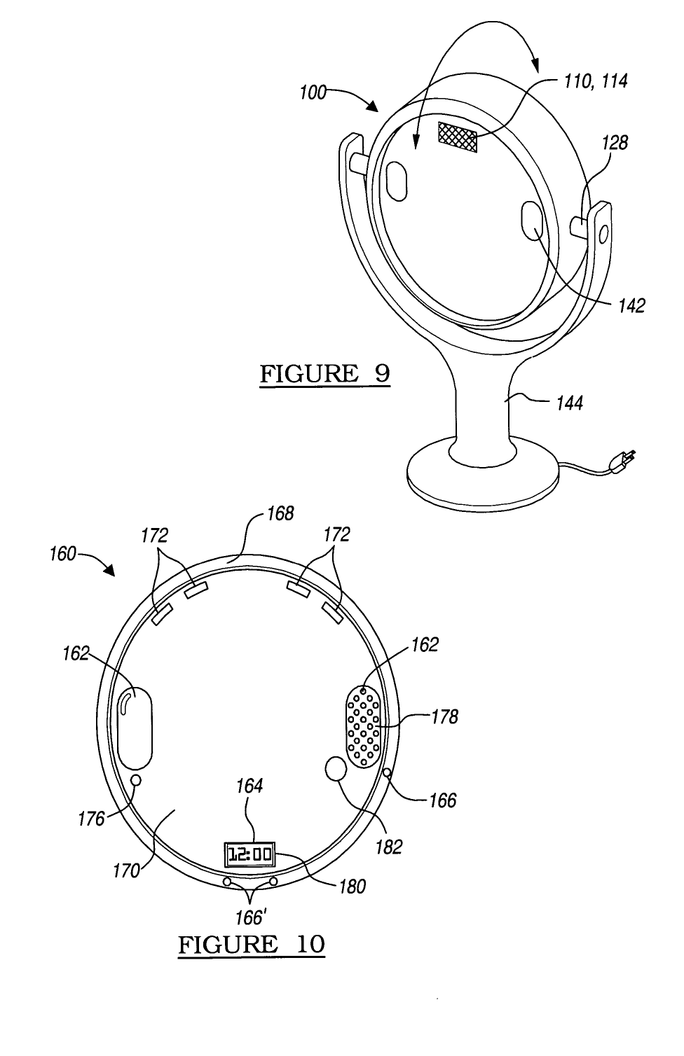

Referring now to FIG. 9, an assembled dual sided cosmetic mirror 100 of the present invention is shown. Pivot axle 128 may pivotably attach to a base 142, allowing dual sided cosmetic mirror 100 to be rotated about the pivot axle. Dual sided cosmetic mirror 100 may include a plurality of information displays 110, 114 and a plurality of light sources 144. Information displays 110, 114 and light sources 142 may be received by first 108 and second 112 substrates, by first 102 and second 104 housings, or by base 142.

Referring now to FIG. 10, a diagram of a cosmetic mirror 160 with a plurality of integrated devices of the present invention is shown. Integrated devices may include at least one light source 162, an information display 164, and at least one button 166.

Light source 162 may be integrated into a housing 168 or a face of a substrate 170. In the spirit of the claimed invention, integration of light source 162 into the face of substrate 170 is accomplished in several ways.

One method is to provide etchings or non reflective portions 172 into the face of substrate 170, the etchings allow light from light source 162 to pass through.

Another method provides substrate 170 with a reflective coating reflecting visibly discernible light, and at least one secondary region 176 passing a portion of the visibly discernible light while simultaneously reflecting a given percentage of the visibly discernible light. The secondary region 176 may be formed by etching a pattern of small appertures in the reflective coating to allow light to pass there through. The average reflectance of entire substrate 170 is greater than about 50%, as disclosed in U.S. Pat. No. 6,005,724, issued on Dec. 21, 1999 and incorporated by reference herein.

Information display 164 may also be integrated into cosmetic mirror 160. Alternatively, information display 164 provides time, date, and weather conditions such as temperature or barometric pressure. Information display 164 may be placed behind a variable light transmission element 180 in order to produce a visual display as disclosed in U.S. Pat. No. 5,530,240, issued on Jun. 25, 1996 and incorporated by reference herein.

Information display 164 may also be placed behind a specially matched portion, as provided above, which is substantially transparent to the spectral band of light emitted from information display 164. Alternatively, substrate 170 has etchings or non-reflective portions corresponding to information display 164 to integrate the information display into substrate 170.

At least one button 166 may also be integrated into either housing 168 or substrate 170 of cosmetic mirror 160 to control devices, such as information displays 164 and light sources 162. At least one button 166 may be a switch or a touch sensor 182. Touch sensor 182 provides input by proximity or touch . Touch sensor 182 connects to a capacitive responsive electronic switching circuit as disclosed in U.S. Pat. No. 5,796,183, issued on Aug. 18, 1998 and incorporated by reference herein. Buttons 166′ may control information display 164, such as a clock. Further, buttons 166 control the intensity or settings for information displays 164 and light sources 162.

Alternatively, buttons 166 connect to an electrostatic rheostat control circuit with a pulse-width modulated output for controlling energization of devices integrated into cosmetic mirror 160 as disclosed in U.S. Pat. No. Re. 35,428, reissued on Jan. 21, 1997 and incorporated by reference herein. The pulse-width modulated signal with a duty cycle is controlled to vary power delivered to the integrated devices.

Preferably, the intensity of light source 162 may be reduced to the point where the cosmetic mirror can serve as a bathroom night light. If desired a photodetector 178 can be provided to sense ambient light to cause the light source to be illuminated at minimal pulse width in low light conditions.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A cosmetic mirror for providing a variable magnification factor comprising:
a housing having an internal annular region oriented about a central axis;
a flexible substrate having a peripheral edge, a front surface, and an opposed rear surface, the peripheral edge being affixed to the housing, the rear surface having a connector extending centrally therefrom;
a reflective coating provided on one of the front and rear surfaces, the reflective coating causing the substrate to be reflective when viewed by a user from the front surface side;
an electric motor/transmission assembly mounted to the housing, the electric motor/transmission assembly having an output member, operably engaged with the connector, for displacing the connector fore and aft relative to the housing annular region and consequently flexing a central portion of the substrate fore and aft relative to the housing annular region thus varying the magnification factor of the flexible surface; and
a user-selectable switch connecting a source of power to the electric motor/transmission assembly for providing user adjustment of the magnification factor.

2. The cosmetic mirror of claim 1, wherein the housing internal annular region limits maximum curvature of the flexible substrate.

3. The cosmetic mirror of claim 1, wherein the connector includes a ball joint.

4. The cosmetic mirror of claim 1, wherein the connector provides an annular connection to the rear side of the flexible substrate.

5. The cosmetic mirror of claim 1, wherein the flexible substrate is provided with a touch sensor cooperating with the switch.

6. The cosmetic mirror of claim 5, wherein the touch sensor is a capacitive switching circuit pad.

7. The cosmetic mirror of claim 1, wherein the housing includes an external portion defining a central opening; and
an internal frame for supporting the flexible substrate and the electric motor/transmission assembly.

8. The cosmetic mirror of claim 1, wherein the switch is received by the housing.

9. The cosmetic mirror of claim 1 further comprising an information display mounted on the front surface of the flexible substrate.

10 The cosmetic mirror of claim 9 further comprising at least one light source mounted on the front surface of the flexible substrate.

11 The cosmetic mirror of claim 10 further comprising the switch mounted on the front surface of the flexible substrate providing control of the information display and the at least one light source.

12. The cosmetic mirror of claim 10 wherein the at least one light source provides a plurality of light modes including a night light setting.

13. The cosmetic mirror of claim 10 wherein the at least one light source provides an automatic shut off feature.

14. The cosmetic mirror of claim 1, wherein the flexible substrate includes at least one non-reflective portion.

15. The cosmetic mirror of claim 14, wherein the at least one non-reflective portion is an opening in the reflective coating.

16. The cosmetic mirror of claim 14 further comprising an information display received by the at least one non-reflective portion and viewable by a user.

17. The cosmetic mirror of claim 14 further comprising at least one light source received by the at least one non-reflective portion.

18. The cosmetic mirror of claim 17 wherein the at least one light source provides a plurality of lighting modes including a night light setting.

19. The cosmetic mirror of claim 17 wherein the at least one light source provides an automatic shut-off feature.

20. The cosmetic mirror of claim 17, wherein the at least one non-reflective portion receives the switch, the switch controlling the information display and the at least one light source.

21. A cosmetic mirror for providing variable magnification comprising:
a housing having an internal annular region formed about a central axis;
a flexible substrate having a peripheral edge, a front surface, and an opposed rear surface, the peripheral edge being affixed to the housing, the rear surface having an annular connector extending centrally therefrom;
a reflective coating provided on one of the front and rear surfaces, the reflective coating causing the substrate to be reflective when viewed by a user from the front surface side; and
a handle shiftably connected to the housing and operably engaged with the connector, where movement of the handle displaces the connector fore and aft along to the housing central axis and consequently flexing a central portion of the flexible substrate thus varying the magnification of an image viewed by the user.

22. The cosmetic mirror of claim 21, wherein the housing assembly limits maximum curvature of the flexible substrate.

23. The cosmetic mirror of claim 21, wherein the annular connector includes a ball joint.

24. The cosmetic mirror of claim 21, wherein the housing includes an external portion defining the opening and annular region; and
an internal frame for supporting the flexible substrate and the handle.

25. The cosmetic mirror of claim 21 includes an information display mounted on the front surface of the flexible substrate and viewable by a user.

26. The cosmetic mirror of claim 25 includes at least one light source mounted on the front surface of the flexible substrate.

27. The cosmetic mirror of claim 26 wherein the at least one light source provides a plurality of light modes including a night light setting.

28. The cosmetic mirror of claim 26 wherein the at least one light source provides an automatic shut off feature.

29. The cosmetic mirror of claim 26 includes a user-selected switch mounted on the front surface of the flexible substrate and connecting a source of power to and providing control of the information display and the at least one light source.

30. The cosmetic mirror of claim 29, wherein the housing receives the user-selectable switch.

31. The cosmetic mirror of claim 21, wherein front surface of the flexible substrate includes at least one non-reflective portion.

32. The cosmetic mirror of claim 31, wherein the at least one non-reflective portion is an opening in the flexible substrate.

33. The cosmetic mirror of claim 31, wherein the at least one non-reflective portion is a substrate window in the flexible substrate.

34. The cosmetic mirror of claim 31 includes an information display received by the at least one non-reflective portion for being viewable by a user.

35. The cosmetic mirror of claim 34 includes at least one light source received by the at least one non-reflective portion.

36. The cosmetic mirror of claim 35 wherein the at least one light source provides a plurality of light modes including a night light setting.

37. The cosmetic mirror of claim 35 wherein the at least one light source provides an automatic shut off feature.

38. The cosmetic mirror of claim 35, wherein the at least one non-reflective portion receives a user-selectable switch connecting a source of power to and providing control of the information display and the at least one light source.

39. The cosmetic mirror of claim 38, wherein the flexible mirror is provided with a touch sensor cooperating with the switch.

40. The cosmetic mirror of claim 37, wherein the touch sensor is a capacitive switching circuit button.

41. A double-sided cosmetic mirror comprising:
a housing with a first end opening and a second end opening;
a first substrate having a first peripheral edge, a first front surface, and an opposed first rear surface, the first peripheral edge being affixed within the first opening of the housing;
a first reflective coating provided on one of the first front and the first rear surfaces, the first reflective coating causing the first substrate to be reflective when viewed by a user from the first front surface side;
a second substrate having a curvature substantially different from the first substrate, the second substrate having a second peripheral edge, a second front surface, and an opposed second rear surface, the second peripheral edge being affixed within the second opening of the housing;
a second reflective coating provided on one of the second front and the second rear surfaces, the second reflective coating causing the second substrate to be reflective when viewed by the user from the second front surface side;
a first information display oriented the first substrate for being viewable by a user;
a second information display oriented the second substrate for being viewable by the user;
an information source circuit connected to and controlling both the first and second information displays; and
at least one user selectable switch cooperating with the information source circuit for controlling the first and second information displays.

42. The double-sided cosmetic mirror of claim 41, further comprising at least one light source received by the housing; and
the at least one switch controlling the at least one light source for selective operation thereof.

43. The double-sided cosmetic mirror of claim 41, further comprising:
at least one first light source mounted on the first substrate;
at least one second light source mounted on the second substrate; and
the at least one switch controlling the at least one first light source and the at least one second light source for selective operation thereof.

44. The double-sided cosmetic mirror of claim 41 further comprising:
a support base; and
a pivot axle mounted to the support base and pivotably attached to the housing for rotating the housing about the pivot axle, and thereby allowing the user to rotate the housing about the pivot axle to view the first front surface and the second front surface.

45. The double-sided cosmetic mirror of claim 41, wherein the information source circuit is a clock circuit.

46. The double-sided cosmetic mirror of claim 41, wherein the first substrate is provided with at least one touch sensor cooperating with the at least one user selectable switch; and
the second substrate is provided with at least one touch sensor cooperating with the at least one user selectable switch.

47. The double-sided cosmetic mirror of claim 41, wherein the at least one user selectable switch is a capacitive switching circuit button.

48. The double-sided cosmetic mirror of claim 41 includes:
at least one first non-reflective portion on the first substrate; and
at least one second non-reflective portion on the second substrate.

49. The double-sided cosmetic mirror of claim 48, wherein the at least one first non-reflective portion is a first opening in the first substrate; and
the at least one second non-reflective portion is a second opening in the second substrate.

50. The double-sided cosmetic mirror of claim 48, wherein the at least one first non-reflective portion is a first substrate window in the first substrate; and
the at least one second non-reflective portion is a second substrate window in the second substrate.

51. The double-sided cosmetic mirror of claim 48, wherein the at least one first non reflective portion cooperates with the first information display; and
the at least one second non reflective portion cooperates with the second information display.

52. The double-sided cosmetic mirror of claim 48, wherein the at least one first non reflective portion cooperates with the at least one first light source; and
the at least one second non reflective portion cooperates with the at least one second light source.

53. The double-sided cosmetic mirror of claim 52 wherein the at least one first light source and the at least one second light source provide a plurality of lighting modes including a night light setting.

54. The double-sided cosmetic mirror of claim 52 wherein the at least one first light source and the at least one second light source include an automatic shut-off feature.

55. The double-sided cosmetic mirror of claim 48, wherein the at least one first non reflective portion oriented with the at least one first switch providing control of the first information display and the at least one first light source; and
the at least one second non reflective portion oriented with at least one second switch providing control of the second information display and the at least one second light source.
